(19) United States
(12) Patent Application Publication
(10) Pub. No.: US 2026/0244478 A1
(43) Pub. Date: Aug. 20, 2026

(54) ARTIFICIAL INTELLIGENCE (AI) DRIVEN OPERATING SYSTEM LIVE UPDATE IN A RESOURCE CONSTRAINED SYSTEM

(71) Applicant: INTERNATIONAL BUSINESS MACHINES CORPORATION, ARMONK, NY (US)

(72) Inventors: Sanket Rathi, Hyderabad (IN); Himanshu Shrivastava, Vidisha (IN); Naresh Bannoth, Sangareddy (IN); Shivarudrappa Satyanaik, Bengaluru (IN)

(21) Appl. No.: 19/055,266

(22) Filed: Feb. 17, 2025

(51) Int. Cl. G06F 9/455

(52) U.S. Cl. CPC G06F 9/45558; G06F 2009/45583; G06F 2009/45591

(57) ABSTRACT

A method, computer system, and computer program product are provided to perform operating system live update. An Autoregressive Integrated Moving Average (ARIMA)-Artificial Neural Network (ANN) hybrid model is created from historical and collected utilization data. A live update program verifies that sufficient free resources are available in the computer system to create a surrogate VM corresponding to an original VM. Based on there not being sufficient free resources, the ARIMA-ANN model predicts workload criticality and resource availability for one or more VMs during a live update duration time window, and the predicts a future time for the live update operation.

### BACKGROUND

The present invention relates generally to the field of computing, and more particularly to live update of operating system software in a resource constrained system.

Customers running business-critical workloads cannot tolerate downtime, even though the downtime may be needed to apply necessary software updates. Technology, referred to as live update or non-disruptive update, exists to update software on running systems. However, if the running system does not have sufficient available resources, either the live update will not execute, or it may fail in progress thereby requiring a recovery.

It would be advantageous to successfully complete a live update of a running system, even in a resource constrained system, thereby avoiding downtime of business-critical workloads.

### SUMMARY

A method, computer system, and computer program product are provided to perform operating system live update. An Autoregressive Integrated Moving Average (ARIMA)-Artificial Neural Network (ANN) hybrid model is created from historical and collected utilization data. A live update program verifies that sufficient free resources are available in the computer system to create a surrogate VM corresponding to an original VM. Based on there not being sufficient free resources, the ARIMA-ANN model predicts workload criticality and resource availability for one or more VMs during a live update duration time window, and the predicts a future time for the live update operation.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of an operating environment before and after a live update according to at least one embodiment;

FIG. 3 illustrates an exemplary hybrid ARIMA and ANN model system architecture, according to at least one embodiment; and

FIG. 4 is an operational flowchart illustrating a live update operation according to at least one embodiment.

### DETAILED DESCRIPTION

The following described exemplary embodiments provide a computer system, computer-implemented method, and computer program product for live update of operating system software in a resource constrained system.

According to an aspect of the invention, there is provided a method to perform operating system live update by creating an Autoregressive Integrated Moving Average (ARIMA)-Artificial Neural Network (ANN) hybrid model from historical and collected utilization data, verifying by a live update program that sufficient free resources are available to create a surrogate virtual machine (VM) corresponding to the original VM. Based on there not being sufficient free resources, predicting by the ARIMA-ANN model, workload criticality and resource availability for one or more VMs during a live update duration time window, and predicting by the ARIMA-ANN model a time for the live update operation.

In this embodiment, the present invention has the advantage of giving a best prediction of resource utilization because CPU and memory utilization for running workloads fluctuate over time. The historical and collected data will include both linear and non-linear components, which are best modeled by the ARIMA-ANN hybrid model. This embodiment has the effect of performing a successful live update operation for the VM without workload interruption.

In the embodiments, creating the ARIMA-ANN model further comprises collecting CPU and memory utilization data from a plurality of VMs for a configurable period of time. The collected data is converted into time series data points, that is input into an ARIMA model. The time series data points are input to the ARIMA model. The residual output from the ARIMA model is input to an ANN model, giving the combined nonlinear and linear outputs. This embodiment has the effect of giving a best prediction for data that comprises both nonlinear and linear data, based on the pattern that is modeled over time from the data.

In the embodiments, the combined CPU and memory utilization data and combined nonlinear and linear outputs from the ARIMA-ANN model are input to a smoothing digital filter, outputting a range of confidence values for predicting a live update duration time window. This embodiment has the effect of increasing the precision of the data without distorting the signal tendency.

In the embodiments, the live update duration window is based on size of the VM being updated. The size comprises an amount of memory and amount of CPUs allocated. This embodiment has the effect of ensuring that the resources needed will be available for the predicted live update duration window.

In the embodiments, the ARIMA-ANN model time for the live update operation is a current time or a future time. This embodiment has the effect of adjusting the time for the live update operation, as predicted by the ARIMA-ANN model to a time, either a current time, or a future time, when the live update operation is most likely to be successful.

In the embodiments, CPU and memory resource is temporarily moved from a VM and allocated to the surrogate VM by criticality, beginning with a least critical VM to a most critical VM, as defined in each VM profile definition. This embodiment has the effect of providing flexibility to ensure the resources needed for the live update duration window are available.

Enterprise computer installations typically host business-critical workloads that require continuous or near-continuous uptime. Additionally, to maximize their return on investment in technology, minimize the requirement for computer room floor space, and reduce power consumption, customers tend to select physical computers that can be configured as multiple virtual environments, referred to as virtual machines (VM).

However, this highly concentrated computing environment is challenging to administer, particularly when installing and updating the operating system (OS) software, here referred to generically as maintenance, is needed and downtime cannot be scheduled. Some architectures provide a live update facility, either as part of their OS or as a separate utility. While these facilities enable simultaneous or near simultaneous distribution and application of maintenance, the computers still need to be restarted to have the maintenance take effect. Additionally, if the VM that will be updated does not have enough available resources, such as CPU, memory, and disk space, either the live update is not performed, or it will fail, requiring a rollback and recovery of the affected OS.

Live update is particularly useful when the software includes updates to the operating system kernel since a kernel update is considered disruptive because it requires a computer reboot. Embodiments of the present invention are particularly applicable to computer architectures that support a dynamic logical partitioning feature. Dynamic logical partitioning reduces the need for systems administrator action, especially when updating software on many VMs.

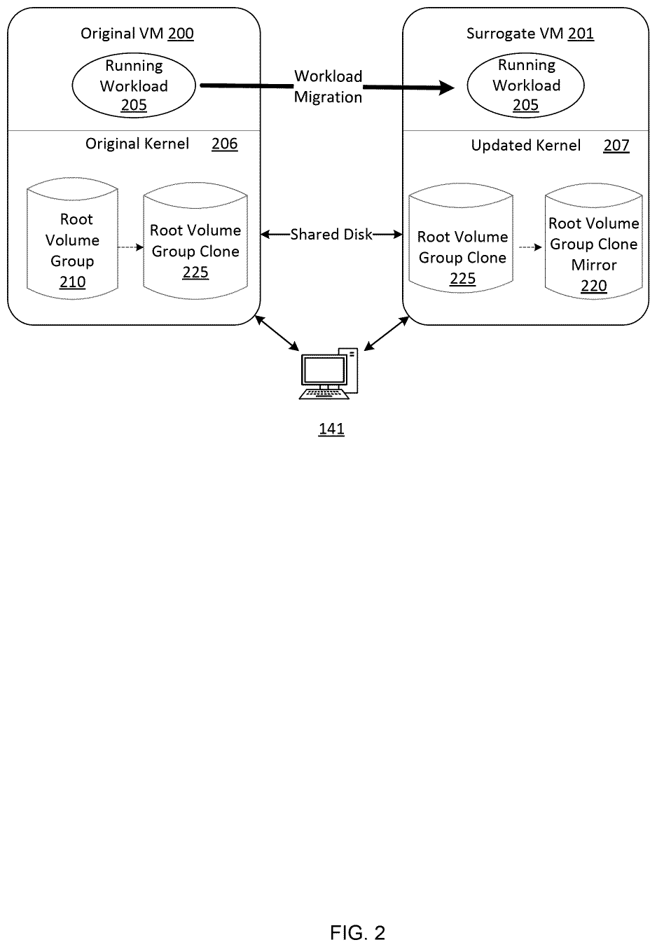

The general live update concept is shown in FIG. 2. For the live update operation occurring on the same system (local), an orchestrator creates a surrogate VM that has the same characteristics, e.g., storage, CPU, memory, as the original VM. The root volume group of the surrogate VM is a cloned image of the original root volume group, including the software updates. After the updated surrogate VM boots, the workload is migrated from original VM to the surrogate VM and then original VM is deleted. The resources allocated to the surrogate VM are released back to the system. The surrogate VM must have the same resources as the original VM to ensure a successful update. If the required resources are not available within the system to create surrogate, the VM live update fails.

Alternatively, if the local system does not have the resources for the live update, the live update can be scheduled on a different system (remote). In this case, the VM to be updated is migrated to the remote system. After successful completion, the VM is migrated back to the original system. This method requires more planning, and two additional migration operations, thereby incurring more overhead.

Previous attempts to enable successful live update in a constrained system include one whereby the systems administrator sets the priorities of VMs in the profile definition of each VM. Each VM's priority can be based on several factors, including the type of workload, performance requirements, service level agreements, and uptime. The systems administrator is not necessarily aware of the workload on the VMs at the time the live update operation is initiated. This may require an extensive pre-planning process where the systems administrator works with stakeholders to analyze the projected workloads during a possible window during which the live update operation might be least impactful. The systems administrator then balances the results of this analysis against the level of potential harm to the VMs by postponing the update. When a VM does not have sufficient resources (CPU, storage, memory, network, etc.) available to satisfy its profile definition to perform the live update, the live update program temporarily moves required resources from other VMs in the system, based on the priorities in their profile definitions. For example, if the VM having the lowest priority has extra resources, these are donated to the surrogate VM up to a defined maximum. If the surrogate VM still cannot be created, the next lowest priority VM is checked for excess resources to donate. This continues until the resource requirement for the surrogate VM is satisfied.

Embodiments of the present invention address these shortcomings by enabling live update of software to occur without stopping running workloads, restarting the computers, or engaging in a lengthy required collaborative planning process with stakeholders, particularly in a resource constrained system. In the present invention the live update program is guided by artificial intelligence (AI) to dynamically define the priorities of the VMs based on the resource utilization of the target VM(s) and the workload at the time the live update operation is initiated. If at the time the live update operation is initiated, the VMs have a full workload and no resources are available, then the AI model, based on historical VM performance data, suggests a best suitable future time for the live update based on the prediction of resources availability, for example, when workload is low and resources can be made available. The historical data includes previously collected resource utilization system logs, traces, and similar data, particularly related to CPU and memory usage. The historical data can also include AI training datasets, and any other intermediate input and output datasets used in the AI model.

Although presented in the context of the AIX® OS, these embodiments may be added to other architectures that support virtual machines, remote management, shared disk storage, and software repositories. AIX® is a registered trademark of IBM Corp., in the US or other countries or both.

In the present disclosure, VMs are not penalized strictly based only on a defined priority. Instead, resources are temporarily borrowed from VMs having lower utilization and with excess resources that are available at the time of the live update, thereby building flexibility into the live update operation. In this context, a low utilization, for example a percentage, can be defined in the VM profile. Excess resources can also be defined in the VM profile as a maximum amount or percentage that the VM can donate. If the required resource are not available, then the live update program, using the AI model, predicts a time window during which utilizations for the VMs will accommodate the live update. Depending on the architectural implementation, the live update program can be a separate software program, such as a virtualization orchestrator, part of the OS, or part of the virtual machine monitor, such as a hypervisor.

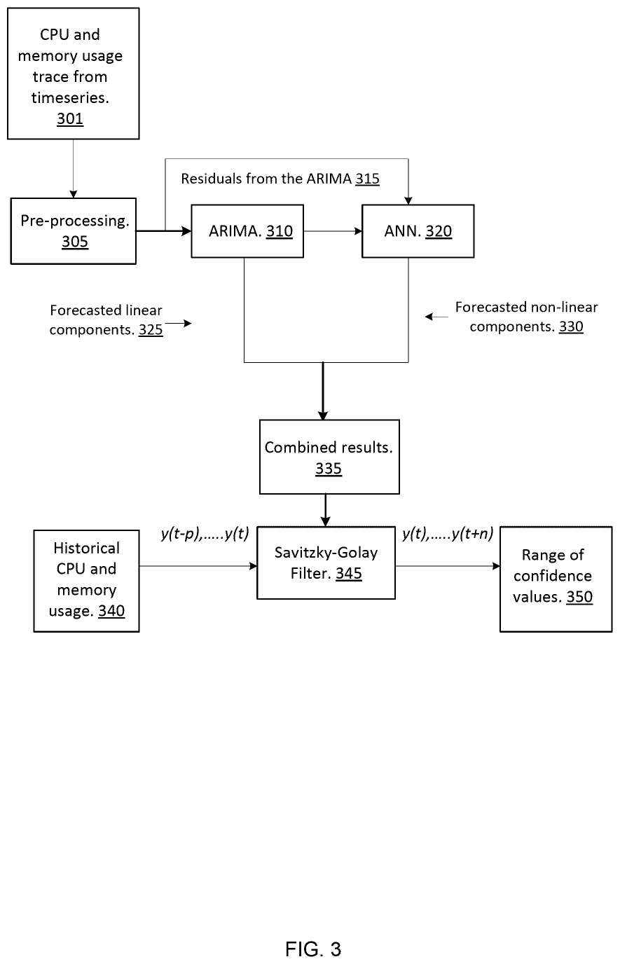

VM resource utilization, such as CPU and memory, likely fluctuates over time in response to running workloads. Therefore, VM performance and utilization time series data will have both linear and non-linear components. Analysis of this type of data is better suited to an Autoregressive Integrated Moving Average (ARIMA)-Artificial Neural Network (ANN) hybrid model, as shown in the hybrid ARIMA-ANN system architecture depicted in FIG. 3.

The linear/non-linear data analysis relies on collected data (301), comprising workload traces, system logs, and actual resource usage records for a workload over a time period, for example a configurable number of “n” days. This data is readily available from system utilities included with the VMs, hypervisors, and OS, or can be collected using any number of available third-party software tools. The collected data provide information of each workload on each VM, such as CPU and memory usage, network throughput and response time, and latency of the input/output (I/O) devices. Similar data can also be collected to measure the performance of the hardware/server on which the VM executes. A timestamp attribute is included in each record collected.

CPU and memory are the key resources required to build the surrogate VM for the live update operation. Therefore, these are the data measurements that will be isolated from the collected data. Also, any null values are removed from the collected data during data preprocessing (305). A time series using CPU and memory usage data points is constructed from the collected data, and any respective error values included in the data. In the auto regression AR(p) model, the current value of the time series is expressed as a linear aggregation of the p previous values and the error term and the moving average MA(q) model is expressed as the current value of time series as an error at time t and q previous error terms.

Time series data points are divided into the training period and the testing period. The training data points fit the models, and the testing data points validate the models.

For training, the constructed time series is sent into the ARIMA model (310), which learns to predict CPU and memory utilization for the next several requests based on the data (325).

Here, the several requests refer to the upcoming time steps for which the ARIMA model predicts CPU and memory utilization. Similar to the time series data, these time steps are collected at regular intervals. The model predicts utilization for the next n intervals based on past heuristic data. The exact number of requests depends on the prediction horizon set for the ARIMA model i.e., as a number of times the time series is fed to ARIMA model.

The nonlinear components that the ARIMA model cannot model are referred to as residuals (315). The residuals are extracted and combined with the original data sequence as input to the ANN model (320). The ANN model generates a collection of CPU and memory use predictions (330). To get the final prediction values, the predicted values from both models are added together (335). These outputs are the final predicted CPU and memory usage load values.

The ARIMA-ANN forecasted CPU and memory load values are basically the final predicted values that are coming as an output of one-time step (Single request or one time series). Now to produce a range of values for future CPU and memory usage prediction, these values are combined with the past history of the CPU and memory load values to create a new time series. This new time series is passed through the Savitzky-Golay filter.

To eliminate any inaccuracies, the collected data 301 is fed into the Savitzky-Golay filter (345) along with the combined results 335. A Savitzky-Golay filter is digital filter that can be applied to a set of digital data points for the purpose of smoothing the data. Smoothing refers to increasing the precision of the data without distorting the signal tendency The range of confidence values (350) for the next several request ahead for CPU and memory use estimate is derived using the smoothed data.

The deployed ARIMA-ANN model is continually updated. As new requests for CPU and memory arrive to a VM, their CPU and memory usage values are incorporated into the time series and the fitting process is repeated. The predicted CPU and memory usage data points along with the past history data points are used in creating the time series, as shown in FIG. 3. The future CPU and memory usage of the VM is predicted to suggest a best suitable time for initiating a non-disruptive live update operation, based on the prediction of resources availability. This may be a current time or a future time.

Retraining the deployed model uses both old and new data, which may result in catastrophic forgetting. This is the tendency of an ANN to abruptly and drastically forget previously learned information upon learning new information. To address this issue, the ARIMA-ANN model is preferably an incremental ensemble ARIMA-ANN model, which fuses ensemble learning and transfer learning to implement incremental updating of the model. Ensemble learning is a machine learning technique that aggregates two or more models to produce more accurate predictions than a single model would. Transfer learning is another machine learning technique in which knowledge gained through one task or dataset is used to improve model performance on another related task and/or different dataset.

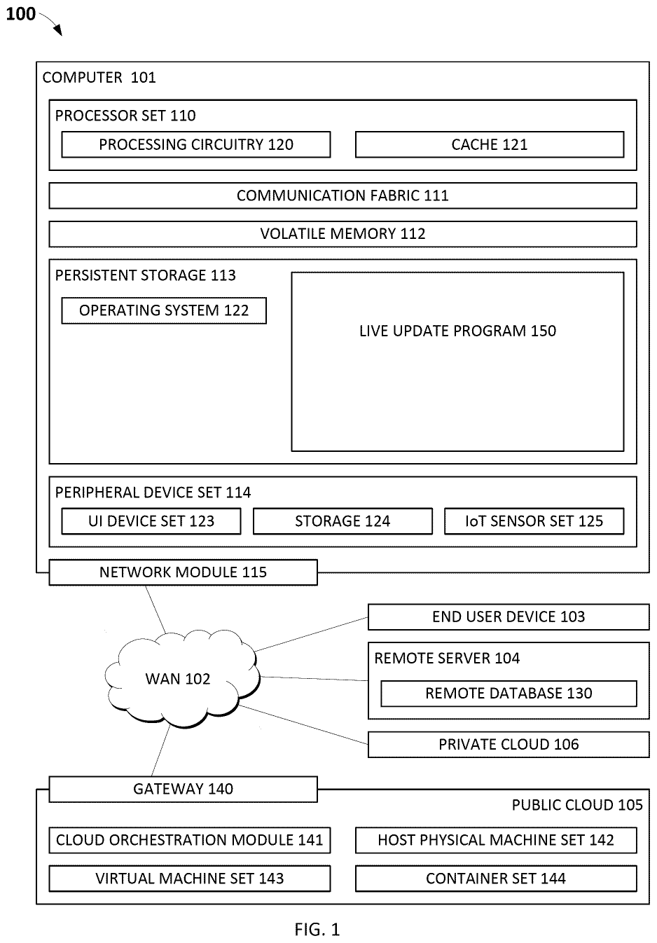

Beginning with FIG. 1, a computing environment 100 according to at least one embodiment is depicted. Computing environment 100 contains an example of an environment for the execution of at least some of the computer code involved in performing the inventive methods, such as live update program (program) 150. In addition to the program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, also referred to as the administrative computer or orchestrator, host physical machine set 142, virtual machine set 143, and container set 144. Furthermore, despite only being depicted in computer 101, the program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 is a schematic block diagram of an operating environment before and after a live update in environments not implementing embodiments of the present invention. Although only two VMs are illustrated, an enterprise computer installation may include many more, all under the control of the orchestrator 141.

Here, the original VM 200 will be updated to become the surrogate VM 201. The original root volume group 210 is cloned to become the root volume group clone 225. The desired software updates are applied to the root volume group clone 225, which is then mirrored to the surrogate VM 201. The root volume group clone 225 on the surrogate VM 201 is mirrored to become the root volume group clone mirror 220. The root volume group clone 225 becomes the boot device for the surrogate VM 201. The software updates may also include updates to the original kernel 206, which will become the updated kernel 207 on the surrogate VM 201. The orchestrator directs the provisioning, validation, and operation of the live update operation. The orchestrator can be implemented on a separate workstation (as shown), or in another VM.

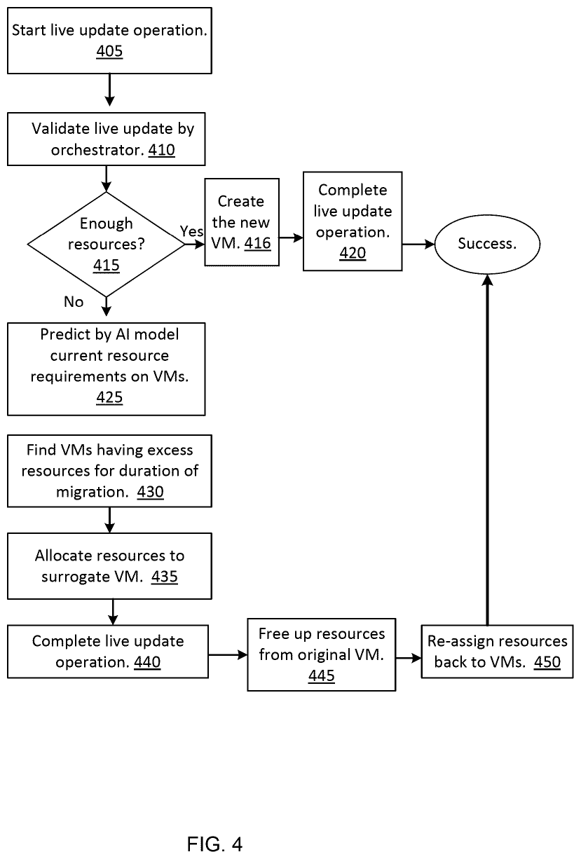

FIG. 4 is an operational flowchart illustrating a live update operation according to at least one embodiment of the present invention. The orchestrator initiates the live update operation (405) a particular VM.

At 410, the live update operation communicates with hypervisor to validate that the required resources are available for creating the new surrogate VM.

If, at 415, enough free resources are available on system, then live update operation creates the surrogate VM (416) and completes the live update operation (420).

If, at 415, there are not enough free resource available on the system, then at 425, the deployed ARIMA-ANN model predicts workload criticality and resource availability for the VMs during the live update duration time window. The duration time window is historical data that is available to the live update operation. It is based on the size of the VM, and indicates the amount of time required for the VM being updated to complete the live update operation. The size refers to a of number of gigabytes of memory and a number of CPUs allocated to the VM. If the ARIMA-ANN model evaluates that the duration time window is available at current time, the live update operation can execute. Otherwise, the ARIMA-ANN model predicts a future time window when VM utilization will be such that enough resources can be made available for the live update operation.

At 430, the orchestrator begins removing resources for the surrogate VM from VMs starting with those VMs having the most excess resources available as predicted by the ARIMA-ANN model, and continuing to those VMs having a least amount of excess resource. Any removal of resource is temporary for the duration of the live update operation, and will not reduce a VM's resources below the minimum required for it to operate.

At 435, once enough resources are available after the dynamic resource operation, the live update operation creates the surrogate VM and performs the live update operation using the surrogate VM (440).

At 445, after the live update operation completes on the surrogate VM, a clean-up begins, whereby the original VM is deleted, and its CPU and memory resources are returned to the corresponding VMs that were the donors (450). However, the CPU and memory resources are returned to the system if they were not borrowed from other VMs.

It may be appreciated that the figures provide only an illustration of one embodiment and do not imply any limitations regarding how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A computer-implemented method to perform operating system live update, the computer-implemented method comprising:
creating an Autoregressive Integrated Moving Average (ARIMA)-Artificial Neural Network (ANN) hybrid model from historical and collected utilization data;
verifying, by a live update program, that sufficient free resources are available in the computer system to create a surrogate virtual machine (VM) corresponding to an original VM;
based on there not being sufficient free resources, predicting by the ARIMA-ANN model workload criticality and resource availability for one or more VMs during a live update duration time window; and
predicting by the ARIMA-ANN model a time for performing the live update operation when sufficient resources are available.

2. The method of claim 1, wherein creating the ARIMA-ANN model further comprises:
collecting CPU and memory utilization data from a plurality of VMs for a configurable time period;
converting the collected CPU and memory utilization data into time series data points;
inputting the time series data points to an ARIMA model;
inputting residual output from the ARIMA model into an ANN model; and
creating combine results, comprising the combining nonlinear and linear outputs from the ARIMA-ANN model.

3. The method of claim 1, wherein the predicting further comprises:
inputting the collected CPU and memory utilization data and combined nonlinear and linear outputs from the ARIMA-ANN model to a smoothing digital filter; and
outputting a range of confidence values for performing a live update operation when sufficient resources are available.

4. The method of claim 1, wherein a live update duration time window is historical data measuring an amount of time required for a VM being updated to complete the live update operation.

5. The method of claim 4, wherein the live update duration time window is based on a size of the VM being updated, wherein size comprises an amount of memory and amount of CPUs allocated.

6. The method of claim 1, wherein the ARIMA-ANN model time for the live update operation is a current time or a future time.

7. The method of claim 1, wherein CPU and memory resource is temporarily moved from a VM and allocated to the surrogate VM by criticality, beginning with a least critical VM to a most critical VM, as defined in each VM profile definition.

8. A computer program product to perform operating system live update, wherein the computer program product comprises a computer readable storage medium having program instructions embodied therewith, the program instructions executable by a processing unit to cause the processing unit to perform a method comprising:
creating an Autoregressive Integrated Moving Average (ARIMA)-Artificial Neural Network (ANN) hybrid model from historical and collected utilization data;
verifying, by a live update program, that sufficient free resources are available in the computer system to create a surrogate virtual machine (VM) corresponding to an original VM;
based on there not being sufficient free resources, predicting by the ARIMA-ANN model workload criticality and resource availability for one or more VMs during a live update duration time window; and
predicting by the ARIMA-ANN model a time for performing the live update operation when sufficient resources are available.

9. The computer program product of claim 8, wherein creating the ARIMA-ANN model further comprises:
collecting CPU and memory utilization data from a plurality of VMs for a configurable time period;
converting the collected CPU and memory utilization data into time series data points;
inputting the time series data points to an ARIMA model;
inputting residual output from the ARIMA model into an ANN model; and
creating combine results, comprising the combining nonlinear and linear outputs from the ARIMA-ANN model.

10. The computer program product of claim 8, wherein the predicting further comprises:
inputting the collected CPU and memory utilization data and combined nonlinear and linear outputs from the ARIMA-ANN model to a smoothing digital filter; and
outputting a range of confidence values for performing a live update operation when sufficient resources are available.

11. The computer program product of claim 8, wherein a live update duration time window is historical data measuring an amount of time required for a VM being updated to complete the live update operation.

12. The computer program product of claim 11, wherein the live update duration time window is based on a size of the VM being updated, wherein size comprises an amount of memory and amount of CPUs allocated.

13. The computer program product of claim 8, wherein the ARIMA-ANN model time for the live update operation is a current time or a future time.

14. The computer program product of claim 8, wherein CPU and memory resource is temporarily moved from a VM and allocated to the surrogate VM by criticality, beginning with a least critical VM to a most critical VM, as defined in each VM profile definition.

15. A computer system to perform operating system live update, the computer-implemented method comprising:
one or more processors;
a memory coupled to at least one of the processors;
a set of computer program instructions stored in the memory and executed by at least one of the processors to perform actions of:
creating an Autoregressive Integrated Moving Average (ARIMA)-Artificial Neural Network (ANN) hybrid model from historical and collected utilization data;
verifying, by a live update program, that sufficient free resources are available in the computer system to create a surrogate virtual machine (VM) corresponding to an original VM;
based on there not being sufficient free resources, predicting by the ARIMA-ANN model workload criticality and resource availability for one or more VMs during a live update duration time window; and
predicting by the ARIMA-ANN model a time for performing the live update operation when sufficient resources are available.

16. The computer system of claim 15, wherein creating the ARIMA-ANN model further comprises:
collecting CPU and memory utilization data from a plurality of VMs for a configurable time period;
converting the collected CPU and memory utilization data into time series data points;
inputting the time series data points to an ARIMA model;
inputting residual output from the ARIMA model into an ANN model; and
creating combine results, comprising the combining nonlinear and linear outputs from the ARIMA-ANN model.

17. The computer system of claim 15, wherein the predicting further comprises:
inputting the collected CPU and memory utilization data and combined nonlinear and linear outputs from the ARIMA-ANN model to a smoothing digital filter; and
outputting a range of confidence values for performing a live update operation when sufficient resources are available.

18. The computer system of claim 15, wherein a live update duration time window is predicted based on load and system configuration.

19. The computer system of claim 18, wherein the live update duration time window is based on a size of the VM being updated, wherein size comprises an amount of memory and amount of CPUs allocated.

20. The computer system of claim 15, wherein the ARIMA-ANN model time for the live update operation is a current time or a future time.
